(19) United States
(12) Patent Application Publication
(10) Pub. No.: US 2002/0087548 A1
(43) Pub. Date: Jul. 4, 2002

(54) Method and protocol for client initiated function calls to a web-based dispatch service

(76) Inventor: Mathew Tasalloti, Maple Ridge (CA)

Correspondence Address: Hall, Priddy, Myers & Vande Sande, Suite 200, 10220 River Road, Potomac, MD, 20854, US

(21) Appl. No.: 09/842,150

(22) Filed: Apr. 26, 2001

(30) Foreign Application Priority Data
Apr. 26, 2000 (CA) 2,306,586

(51) Int. Cl. G06F 7/00

(52) U.S. Cl. 707/10

(57) ABSTRACT

A function calling method and protocol for use in association with accessing a web-based Dispatching System that includes a WEB System, a Mobile Worker System and a Dispatch Server. A function is call is performed through a WEB browser running on an Internet appliance utilizing a Uniform Resource Locator (URL), and the results of the function call are returned to the Internet appliance.

### FIELD OF THE INVENTION

This invention relates generally to dispatch services. More specifically, this invention relates to a method and protocol for making client initiated function calls via the Internet to a web-based dispatch service.

### BACKGROUND OF THE INVENTION

The Internet

The Internet is a collection of interconnected public and or private networks linked together by a set of standard protocols to form a global distributed communications network. The World Wide Web (Web) generally refers to the collection of computer applications or user viewable documents accessible via the Internet from a user's computer. The distributed network of the Web is often described as a client-server system in which a program at one location sends a request to a program at another location and waits for a response. The requestor is the “client” and the responder is the “server”. Such computer-to-computer interactions are also referred to as “application-to-application” interaction. TCP/IP (Transmission Control Protocol/Internet Protocol, HTTP (HyperText Transport Protocol) and HTML (HyperText Markup Language) are the standard protocols used throughout the Internet. TCP/IP specifies clients/servers exchange data over the Internet, and specifically handles such issues as data packetization, packet addressing, handshaking, and error correction.

HTTP is used for document exchange between a web browser (browser) and a web server. HTTP includes a number of different types of messages that are entered into the browser (i.e. the client) and sent via the Internet to a Web Server (i.e. server) to cause the server to perform various functions. The syntax of a typical HTTP message is <HTTP message><URL>, where URL or Uniform Resource Locator is a unique address specifying the location of a file or other resource on the Internet. The most common HTTP commands are: GET <URL>, which causes the server to return the document or file located at URL; and POST <PAYLOAD>, which causes the web server to accept information as defined by PAYLOAD from the client. Incoming HTTP requests are directed by TCP/IP to port 80 on the web server which is the default port for HTTP.

HTML is a standard coding convention used for attaching presentation attributes called “tags” to informational content in documents. When a document is sent from a server to a client, the client browser interprets the tags within the document and displays the document according to the instructions specified by the tags.

One problem with Internet applications, such as the web-based dispatch service, is often client computer applications are required to interface directly to other host-based applications. Historically this application-to-application interaction is accomplished via custom software applications using DCOM, IIOP or CORBA technologies. DCOM, IIOP and CORBA impose limitations on both the client and server in that they require both entities to be running their appropriate application in order to function.

Unfortunately, the Internet does not specify or guarantee what type of client or server software is running at either end of the communications link. The Internet only guarantees that TCP/IP and HTTP protocols will be used. Therefore the challenge to this problem is to use only existing Internet standards such as HTTP that is not tied to any operating system, programming language or object model.

Several solutions have been proposed for this problem. U.S. Pat. No. 5,987,517 (Firth et al.) proposes a library of re-entrant networking functions for inclusion in client applications. These functions allow application programs to be written for the Internet without large amounts of source code to manage the details of HTTP and TCP/IP. U.S. Pat. No. 5,974,443 (Jeske) proposes using a generic HTML template file as a storage means for data retrieved from a database. U.S. Pat. No. 5,835,712 (DuFresne) proposes embedding HTML tag extensions for client-server interactions. The basic unit of information between the client-server is assumed to be an HTML page and the server must parse for the extensions and execute custom code related to these custom tags. U.S. Pat. No. 5,956,483 (Grate et al.) proposes a method and protocol for embedding client-side function calls within HTML documents.

Unfortunately, the above-mentioned patents fail to address the problem of finding a method for application-to-application interaction without requiring modifications or additions to existing HTTP or HTML.

Microsoft Corporation has proposed a solution to this problem by proposing a new protocol called SOAP (Simple Object Access Protocol. SOAP defines a mechanism to pass commands and parameter between HTTP clients and servers. The SOAP solution is to provide an extension to HTTP headers and associated data to provide application-to-application communication over the Internet. Unfortunately, SOAP also does not provide a solution to the stated problem as it requires major extensions to the present HTTP set of commands.

It is an object of the present invention to provide a method and protocol for access to a web-based dispatch system and associated services for making client initiated function calls.

It is a further object of this invention to provide access to the web-based dispatch system and associated services using the standard Internet protocols TCP/IP, HTTP and HTML, without any additions or modifications.

It is an additional object of this invention to provide a method and protocol that will support both application-to-application interactions, as well as manual entry via a standard web browser.

It is still another object of the present invention that the protocol support multiple import and export data formats.

It is a still further object of this invention to provide access to the web-based dispatch system and associated services in a relatively simple and easy to use manner.

### SUMMARY OF THE INVENTION

These and other objects of the invention are provided in a new and improved method and protocol for accessing a web-based Dispatching System that includes a WEB System, a Mobile Worker System and a Dispatch Server. The Dispatching System is arranged such that the WEB System and the Mobile Worker System both access the Dispatch Server via the Internet. It should be noted that throughout this description responsibilities and tasks indicated for each of the components of the Dispatching System are merely representative of the tasks that may be performed and do not reflect the complete set of such tasks and responsibilities.

WEB System

The WEB System may consist of a plurality of WEB System clients. The WEB System clients may be of a variety of different types wherein each of the clients may be of one of the following types: Dispatch Client, Admin Client, Service Provider Client and Customer Computer System.

The Dispatch Client is responsible for tasks such as creating and entering jobs to be dispatched, assigning jobs to field workers, monitoring the status and progress of jobs and reassigning jobs.

The Admin Client is responsible for performing configuring and maintaining parameters of the system such as work zones, user accounts, vehicle records, service records, worker attributes, vehicle attributes and patron addresses.

The Service Provider Client is an entity responsible for providing web dispatch services to its customers. The Service Provider Client performs tasks such as billing, service administration and system monitoring. Essentially, the Service Provider Client is a combination of the Dispatch Client and the Admin Client with access to a subset of the tasks of each.

The Customer Computer System is responsible for interfacing with a particular customer's accounting, work management and scheduling systems thereby allowing a customer to administer their information in the Dispatching System. The Customer Computer System accesses the Dispatching System via an interface called the eDAPI Interface, which is the focus of this invention.

In general, the WEB System clients are a standard personal computer (PC) capable of running a standard web browser. The WEB System clients access the Dispatch Server over the Internet. Each WEB System client will be able to access client specific pages from the Dispatch Server. If the Dispatch Client is the only WEB System client, the Dispatch Client will have access to all of the client pages in order to carry out all of the WEB System responsibilities.

Mobile Worker System

The Mobile Worker System interface consists of a plurality of Mobile Worker Clients, at least one Wireless Network and at least one Wireless Proxy Server. The Mobile Worker Clients are wireless RF devices capable of running either a full browser or micro-browser. These wireless RF devices may include a two-way pager, a digital phone and a mobile data terminal. The Mobile Worker Clients represent actual mobile workers in the field.

The Mobile Worker Clients access the Dispatch server either through the Internet, through a Wireless Network or through the combination of a Wireless Network and a Wireless Proxy Server. The Mobile Worker Clients can receive job dispatches and information from the Dispatch Server and can return information regarding job acceptance, job completion, and job status or request information from the Dispatch Server.

The general term Internet appliance refers to any device capable of running a web browser, whether that be a full browser or a micro-browser, and capable of accessing the Internet.

Dispatch Server

The Dispatch Server is comprised of four logical components: the Web Server, the Dispatch Application Logic, the Database Server and the Dispatch Database.

The Web Server

The clients of the WEB system and the Mobile Worker System interact with the Dispatch Server over the Internet through the Web Server. Web pages that are specific to particular clients are implemented on the Web Server. These web pages provide the interfaces for each of the clients. Through the use of these interfaces, the functionality of each of the clients is realized.

The Dispatch Application Logic

The Dispatch Application Logic (DAL) is the core of the dispatching system providing the logic essential to the integrated operation of the Dispatch Server, WEB System and Mobile Worker System. All transactions between the various components of the Dispatching system must pass through the DAL. All data manipulation, client response and web page creation functions are handled through the DAL. The DAL is also specifically responsible for job dispatching to field workers, job monitoring, job scheduling and system monitoring.

The Database Server and Database

The Database Server and Database are industry standard components and are well known in the art. The Database Server and Database are crucial components of the system as all of the customer information, dispatch information and mobile worker information is stored in the Database. Routines are employed that ensure that customers have access only to their own data utilizing unique record identifiers.

The present invention provides a method and protocol for accessing the above mentioned components and associated services and functions of the web-based dispatch system via the Internet via a standard interface called eDAPI. The eDAPI Interface is a data exchange mechanism which can be used to up-load and download data from the Dispatch Server to the Customer Computer Systems via the Internet. In the preferred method the eDAPI Interface is an HTTP interface to the eDAPI Functions of the Dispatch Application Logic which can be invoked by either manually or via application-to-application interaction.

Other objects and advantages of the invention will become clear from the following detailed description of the preferred embodiment, which is presented by way of illustration only and without limiting the scope of the invention to the details thereof.

### BRIEF DESCRIPTION OF THE DRAWINGS

Many objects and advantages of the present invention will be apparent to those of ordinary skill in the art when this specification is read in conjunction with the attached drawings wherein like reference numerals are applied to like elements and wherein:

FIG. 1 is a block diagram representation of a web-based dispatching system according to an embodiment of this invention;

FIG. 2 is a decision tree outlining the general operation of a dispatch system according to an embodiment of this invention; and

FIG. 3 is a decision tree outlining a basic request/response transaction between a requester and a responder in an embodiment according to this invention.

### DETAILED DESCRIPTION OF THE INVENTION

Architecture

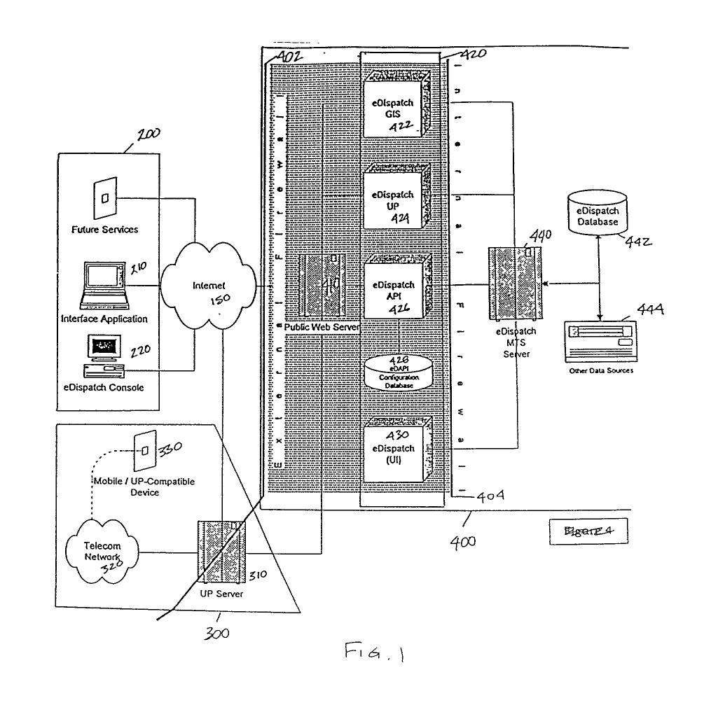

Referring to FIG. 1, a client/server architecture of a web-based dispatching system 100 in accordance with the invention is illustrated. The dispatching system 100 consists generally of: a WEB system 200, a mobile worker system 300, the Internet 150 and a dispatch component 400.

The WEB system 200 is comprised of a plurality of clients that can generally be categorically divided into either interface applications 210 or dispatch consoles 220. All of the clients, regardless of category, require only a web browser as the client software component, and all clients interact with the dispatch component 400 via the Internet 150.

The interface applications 210 include admin clients and customer computer clients. As the name suggests, admin clients are generally responsible for performing universal administrative operations such as configuration and maintenance of the dispatch system 100. Admin clients perform tasks including demarking work zones within a geographic area, initializing and configuring user accounts, vehicle records, service records, attributes of mobile workers, attributes of vehicles and customers accounts and information. Customer computer clients perform the same tasks as the admin clients but are limited to the administrative operations of a particular client. In this way, a customer may configure the information and the elements of the system (i.e. mobile workers, vehicles, work zones, etc.) utilized by the customer to suit the customer's particular requirements. The customer computer client also has the ability to upload and/or download accounting and administrative data between the client and the dispatch component 400.

The dispatch consoles 220 include service provider clients and dispatch clients. A dispatch client performs tasks such as entering jobs to be dispatched, assigning jobs to mobile workers and monitoring the status and progress of jobs. A service provider client acts to provide dispatching services to its customers. The service provider client performs the same tasks as the dispatch client and performs a subset of the tasks of a computer system client.

The mobile worker system 300 consists of a wireless proxy server 310, a telecom network 320 and a plurality of mobile devices 330. In most cases, the mobile devices 330 will be WAP-enabled running either a full web browser or a mini-browser or microbrowser. For example, the wireless proxy server 310 may be an UP.Link Server and the mobile devices 330 may be UP compatible devices running the UP.Browser microbrowser. The wireless proxy server 310 interacts with the dispatch component 400 through the Internet 150, through a network connection, or both.

The general term Internet appliance refers to any device capable of running a web browser, whether that be a full browser or a micro-browser, and capable of accessing the Internet. Members of the WEB system 200 and members of the mobile worker system 300 will be Internet appliances.

The dispatch component 400 is the heart of the dispatching system 100. The dispatch component 400 comprises an external firewall 402, a public web server 410, dispatch web server 420, an internal firewall 404, a dispatch transaction server 440, a dispatch database 442 and an alternate data source 444.

The external firewall 402 is the main access filter to the dispatch component 400. The external firewall 402 ensures that only the HTTP port may be opened for bi-directional traffic, allows an external messaging port to be opened to send outbound messages and ensures that only the public web server 410 is contacted.

The public web server 410 acts as the access point for the web system 200 and the mobile worker system 300. The public web server 410 receives requests from the web system 200 and the mobile worker system 300 and forwards the requests to the dispatch web server 420.

The dispatch web server 420 further comprises a dispatch GIS 422, a dispatch UP 424, a dispatch API 426 with a dispatch API configuration database 428, and a dispatch UI 430.

The dispatch GIS 422 is the geographic information system of the dispatch system 100. The dispatch GIS 422 can take input in the form of digitized or scanned maps. This input is then converted into geographic data. The geographic data can be stored in many forms including vector graphics and raster graphics formats. The geographic data will be stored in either the dispatch database 442 or an alternate data source 444. As an example, queries of the geographic data allow the retrieval of information regarding distances between to points, the best route to travel between two points, the locations of mobile workers and the boundaries of work zones.

Basic Operation

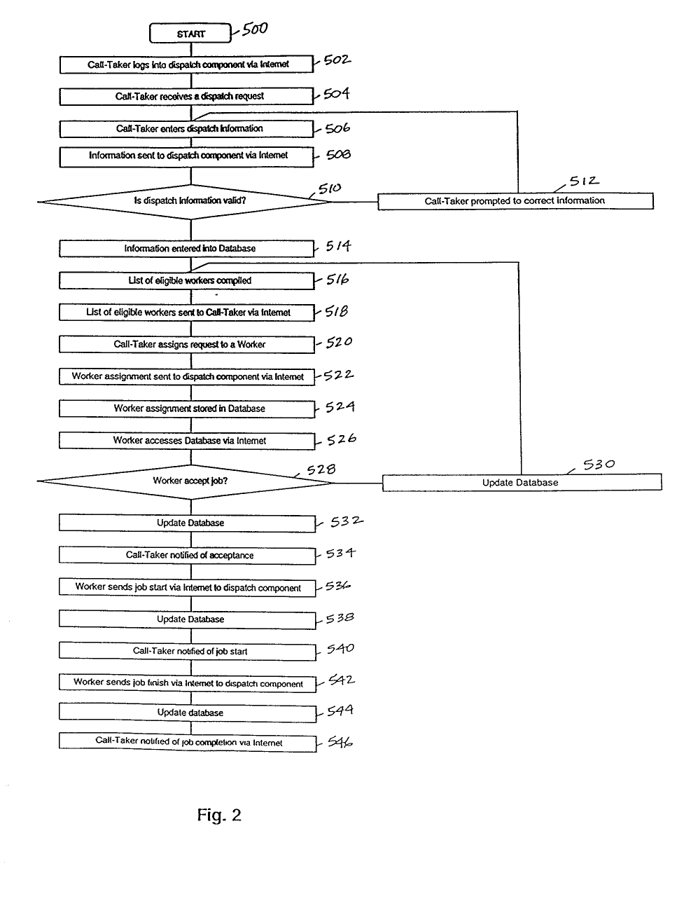

Referring to FIG. 2, the decision tree demonstrating the basic operation of a transaction in the Dispatch System 100 is given. In this example, the Call-Taker is a member of the web system 200, and the Worker is a member of the mobile worker system 300. The system is initiated at step 500. At step 502, the Call-Taker logs into the Dispatch Component 400.

At step 504, the Call-taker receives a dispatch request from a Patron. The Call-Taker enters this information in the dispatch console 220 (step 506) and the information is sent to the dispatch component 400 (step 508) via the Internet 150. At step 510, the dispatch component 400 determines the validity of the information. For example, the information may be tested to determine if the postal code and the address match or simply to check if any information was omitted. If the information is not valid, at step 512 the dispatch component 400 sends a message to the Call-Taker, via the Internet 150, prompting the Call-Taker to correct the information and then the Call-Taker is returned to step 506.

If the information entered at step 506 is valid, at step 514 the information is entered into the database 442 or 444. Next, at step 516, the dispatch API 426 compiles a list of eligible workers. Workers' eligibility will be based on several criteria that may include, the location of the worker, the skill set of the worker, the equipment carried by the worker, etc. Once the list of eligible workers has been compiled, it is sent via the Internet 150 to the Call-Taker (step 518). At step 520, the Call-Taker assigns the dispatch request (i.e. job) to a worker. In general, the Call-Taker will assign the job to a worker listed on the eligible list. However, the flexibility of the Dispatch System 100 allows the Call-Taker to assign the job to any worker. At step 522, the assignment is sent from the dispatch console 220 to the dispatch component 400 via the Internet 150. The worker assignment is stored in a database 442 or 444 (step 524) and the worker then accesses the information stored in the database 442 or 444 via the Internet 150 and the dispatch API 426 (step 526). The worker may access the information stored in the database 442 or 444 when checking for another job or the worker may receive a notification to request information from the database 442 or 444. At step 528, the worker decides if he will accept the assigned job. If the worker does not accept the assigned job, then the database will be updated by the dispatch API 426 to reflect the job refusal (step 530) and the system returns to step 516.

If the worker accepts the job, the database is updated by the dispatch API 426 (step 532) and the Call-Taker is notified of the acceptance (step 534). The worker will then send a job start message to the dispatch component 400 via the Internet 150 to indicate he has commenced the job (step 536). At step 538, the dispatch API 426 updates the database 442 or 444 to reflect the job start and the Call-Taker is notified of the job start (step 540).

When the worker has completed the job, at step 542, the worker sends a message via the Internet 150 to the dispatch component 400 indicating the job has been completed. At step 546, the dispatch API 426 updates the database 442 or 444 and notifies the Call-Taker of the job completion (step 548).

The operation of the Dispatch System 100 described above may have several streams of the decision tree running simultaneously, with all transactions coordinated through the dispatch API 426.

General

The dispatch API 426 provides an HTTP-based API set that will provide clients with access to the dispatch database and the dispatch services. The dispatch API 426 requires only a standard web browser as the client software component to interact with the dispatch API 426.

Throttling

The dispatch API 426 includes a throttling mechanism. The throttling mechanism allows the dispatch API 426 to limit the resource usage by clients and protect itself against overloading by client requests and malicious attacks. The throttling mechanism operates on several levels simultaneously. The throttling mechanism can limit the number of simultaneous or near simultaneous requests made by a single client. Also, the throttling mechanism can limit the number of simultaneous requests received by the dispatch API 426 at any given point in time. Throttling also allows client to be classified in various priority levels. All of the settings for the throttling mechanism are configurable allowing the system to be adaptable to various hardware, software and client configurations.

Transaction Object

Transaction objects are the means by which the dispatch API 426 provides the clients 210, 220, and 330, with access to the dispatch services. Each transaction object defines the dispatch API 426 interface functions that are made available to each of the clients 210, 220 and 330. Each transaction object defines the parameters that are required and must be passed by any particular client.

The dispatch API 426 supports dynamic transaction objects. Dynamic transaction objects allow the creation of client-callable transaction objects such that a client can call to initiate services. In general, the transaction objects will be called using the HTTP POST method and the results of these transactions will be returned to the client using XML encoding.

One of the keys of the dispatch API 426 is that it maintains the integrity of the transactions. Any request for services initiated through the dispatch API 426 will be required to preserve the system integrity and any data delivered to the client must be sound.

Configuration

The dispatch API 426 is a configurable subsystem that is configured and installed for each client 210, 220, 330. The clients 210, 220 and 330 of the dispatch API 426 will access data through an IP network through the use of HTTP-based functions.

The configuration of the dispatch API 426 can take place at various levels ranging from the client level to the administrator level. Further, the system may be configured locally or remotely. In general, those clients, administrators, etc. that have the necessary access permissions to configure aspects of the system will be termed generically as configurators.

The dispatch API 426 allows the creation of transaction objects. A transaction object is essentially the function calls made available to clients 210, 220 and 330. From a configuration point of view, the dispatch API 426 must be able to configurably define transaction object for each client 210, 220 and 330. For example, a client 210, 220 and 330 may not be authorized to access particular transaction objects that other clients may be using. Also, a client 210, 220 and 330 may need to receive only certain fields of a transaction therefore the remaining fields should be hidden from the clients. Configurators specify the transaction object fields that are sent to each client 210, 220, 330.

Security

Due to the potentially sensitive nature of information that will be exchanged between clients 210, 220, and 330, and the dispatch API 426, clients will require explicit registration and permissions to access the dispatch API 426. Security requires strict measures to positively identify a client logging into the system. For example, client ID and password authentication, registered Internet access points and certificate based transmission encryption for data in transit may be used individually or in combination.

The network firewalls 402 and 404 will only expose the HTTP port of the dispatch API 426 to the Internet 150. In this manner, Internet users, and potentially unscrupulous clients, would not be able to break into the dispatch API 426 and gain access to the core network and databases.

The dispatch API 426 supports the encryption of data in transmission using data encryption techniques such as Secure Sockets Layer/HTTPS.

Data Delivery

In a typical transaction, the clients 210, 220, and 330 will make requests to the dispatch API 426. The dispatch API 426 will process the transactional request and send the client the results of the transaction. The results of a client 210, 220 and 330 transaction are sent back as an HTTP document. As a result, the results are processed as any standard HTML browser transaction. In fact, the dispatch API 426 requires that the system be accessible through a standard HTML browser.

Data Access

When a client 210, 220, 330, makes a request to the dispatch service, there are three components to the request. In general, the request will consist of a header, parameters and the results produced, if any.

The header is essentially the Uniform Resource Locator (URL) or Web address of the public web server 410 to be interfaced. The general form of the header will be:

http://www.<site_name>.com/<dir_name>/eDAPI.asp?CMD=<func_name>

where <func_name> is the name of the function to be called. The variable <site_name> represents the webserver through which the client 210, 220 or 330 will be accessing the dispatch services. For example, different classes of users and different classes of clients may access their requested function through various webservers or various directories within a web server. The <dir_name> variable is the name of a directory housing the eDAPI.asp file. All requests made to the dispatch services must be made through the eDAPI.asp file. The <dir_name> may also represent a path for access to the eDAPI.asp file.

The parameters for the request must include at least the name of a transaction object (CMD) to be invoked by the request, the ID of the company that the client belongs to (CID), the user ID of the client (UID), and the client's password (PASS).

The general operation of the dispatch system 100 involves a plurality of request/response transaction between various components of the dispatch system 100. A description of a basic request/response transaction between a client 210, 220 or 330 and a responder, in this case the dispatch component 400.

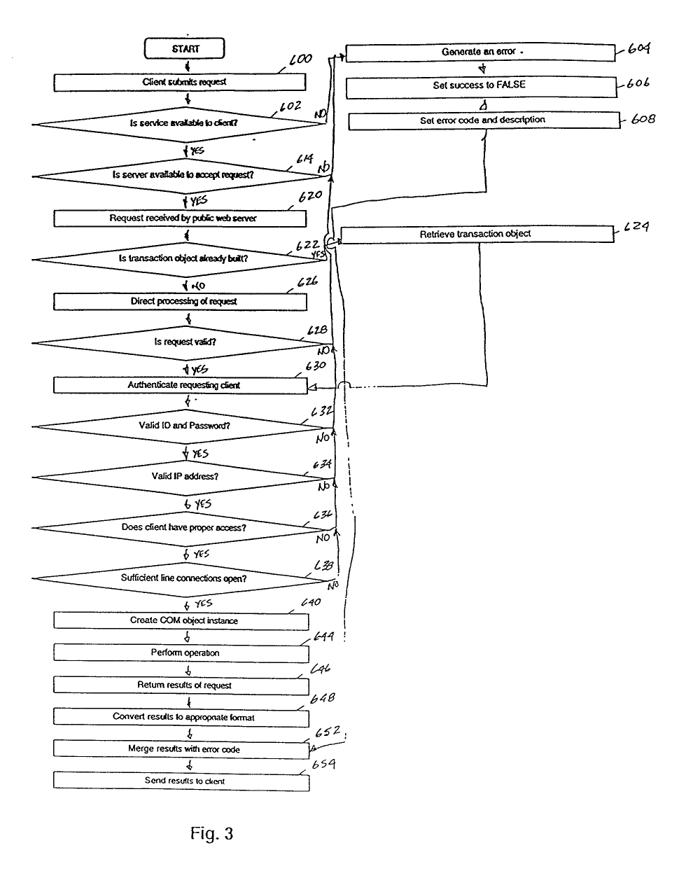

Referring to FIG. 3, a basic request/response process is outlined. The process is initiated when a client 210, 220, 330, submits a request (step 600). At step 602, the public web server 410 determines if the client 210, 220, 330 is eligible to use the dispatch service. If a client 210, 220, 330, is not eligible to use the dispatch service, then an error is generated (step 604). The error generation process first sets the success flag to FALSE (step 606) and then at step 608 the error code, error description and number of records returned are set. The generated error is then merged with any records that may be returned (step 652) and the results are forwarded to the requesting client 210, 220, 330 (step 654).

If at step 602, the client 210, 220, 330, is eligible to use the dispatch service, then at step 614, the public web server 410 determines if the dispatch API 426 is available to accept a request. If the dispatch API 426 is not available to accept a request, then an error is generated (step 604). The error generation process first sets the success flag to FALSE (step 606) and then at step 608 the error code, error description and number of records returned are set. The generated error is then merged with any records that may be returned (step 652) and the results are forwarded to the requesting client 210, 220, 330 (step 654). If the dispatch API 426 is available to accept a request, then the request is transferred to the dispatch API 426.

When the request is received by the dispatch API 426 (step 620), the dispatch API 426 determines if a transaction object is already built for the request (step 622). If a transaction object does exist for the request, then at step 624, the transaction object is retrieved. Once the transaction object has been retrieved, the process moves to step 630.

If a transaction object does not exist for the request, then at step 626, the request will be processed directly and the appropriate transaction object created. The process then moves to step 628.

At step 628, the dispatch API 426 determines if the request made by a client 210, 220, 330, is a valid request. A request is valid if it invokes the building of the proper transaction object and all of the required parameters are present in the request. If the request is not valid, then an error is generated (step 604). The error generation process first sets the success flag to FALSE (step 606) and then at step 608 the error code, error description and number of records returned are set. The generated error is then merged with any records that may be returned (step 652) and the results are forwarded to the requesting client 210, 220, 330 (step 654).

If the request is valid, then at step 630 the client 210, 220, 330, is authenticated. During authentication, at step 632, the dispatch API 426 determines if the client user ID and client password are valid. If either the client user ID or client password is not valid, then an error is generated (step 604). The error generation process first sets the success flag to FALSE (step 606) and then at step 608 the error code, error description and number of records returned are set. The generated error is then merged with any records that may be returned (step 652) and the results are forwarded to the requesting client 210, 220, 330 (step 654).

If the client user ID and client password are authenticated, then the dispatch API 426 determines if the client IP address from which the request originates is valid (step 634). If the client request does not originate from a valid IP address then an error is generated pursuant to the error generation process described above (steps 604 to 608 and steps 652 to 654).

If the client request does originate from a valid IP address, then the dispatch API 426 determines if the client 210, 220, 330, has the appropriate access privileges to perform the requested operation (step 636). If the client does not have the appropriate access privileges to perform the requested operation, then again, an error is generated pursuant to the error generation process described above (steps 604 to 608 and steps 652 to 654).

If the client does have the appropriate access privileges to perform the requested operation, then the dispatch API determines if there are sufficient connections open to perform the requested operation (step 638). At this step, the dispatch API 426 is addressing the throttling concerns of the system to ensure that resource usage is limited and the system does not become overloaded. If there are not sufficient connections open to perform the requested operation, again, an error is generated pursuant to the error generation process described above (steps 604 to 608 and steps 652 to 654).

If there are sufficient connections open to perform the requested operation, then at step 640, an instance of the required COM objects is created. At step 644, the requested operation is performed by the dispatch API 426. Next, the results of the operation, if any, are returned in XML format (step 646). At step 648, the results are converted from XML to the appropriate format for the client 210, 220, 330, if necessary. In some cases, the XML format will be appropriate for the requesting client.

At step 652, the resulting records are merged with the results of the error generation process. If an error has not been generated during the request/reply process then success will be set to true and the number of records returned will be indicated.

At step 654, the merged results are sent back to the requesting client.

Indicated below is a generic sample of the status portion of an XML result of a request:

<DISPATCH_API>

<RETURN_STATUS SUCCESS = [TRUE | FALSE]>

<CODE>?</CODE>
<DESC>?</DESC>
<RECS>?</RECS>

</RETURN_STATUS>
. . .

</DISPATCH_API>

The RETURN_STATUS variable indicates whether the operation that was performed was success or unsuccessful. The CODE variable is a unique error code within the system that can be referenced for a detailed description of the error that occurred. In general, the CODE will indicate one of three conditions, error, success or warning. An error is indicated when the value of CODE is less than zero (CODE <0). Success is indicated when the value of CODE is equal to zero (CODE=0). And a warning is indicated when the value of CODE is greater than zero (CODE >0). The DESC variable is a brief textual description of the error that occurred. For example, when CODE=0 then DESC will be equal to “SUCCESS”. The RECS variable indicates the number of XML records/objects that can be found on the returned page.

An example of a complete function result with returned records is indicated below:

<DISPATCH_API>

<RETURN_STATUS SUCCESS = TRUE>

<CODE>0</CODE>
<DESC>SUCCESS</DESC>
<RECS>2</RECS>

</RETURN_STATUS>
<DEVICE>

<SYS_CO_ID>2</ SYS_CO_ID>
<CO_CODE>EDW</CO_CODE>
<SYS_DEVICE_ID>45</SYS_DEVICE_ID>
<DEVICE_NAME>d001.aa.bb.ca</DEVICE_NAME>
<DEVICE_SERIAL_NUM>001</DEVICE_SERIAL_NUM>
<DEVICE_ALERT_TYPE>2</DEVICE_ALERT_TYPE>
<DEVICE_ALERT_EMAIL>name01@email.com
</DEVICE_ALERT_EMAIL>
<DEVICE_COMMENTS>Handspring Visor Deluxe
</DEVICE_COMMENTS>

</DEVICE>
<DEVICE>

<SYS_CO_ID>3</ SYS_CO_ID>
<CO_CODE>EDW</CO_CODE>
<SYS_DEVICE_ID>46</SYS_DEVICE_ID>
<DEVICE_NAME>d002.aa.bb.ca</DEVICE_NAME>
<DEVICE_SERIAL_NUM>002</DEVICE_SERIAL_NUM>
<DEVICE_ALERT_TYPE>2</DEVICE_ALERT_TYPE>
<DEVICE_ALERT_EMAIL>name02@email.com
</DEVICE_ALERT_EMAIL>
<DEVICE_COMMENTS>Palm Pilot
</DEVICE_COMMENTS>

</DEVICE>

</DISPATCH_API>

In order to provide the dispatch API 426 functionality as previously described, the functions, summarized in Tables 1 to 5, represent the minimum set of functions carried out by the dispatch API 426.

TABLE 1
System Admin Functions

| Function | Description |
|---|---|
| AdminEnableServer | Enable the server to accept incoming requests. |
| | May be system wide or company specific. |
| AdminDisableServer | Disable the server to accept incoming requests. |
| | May be system wide or company |
| | specific. |
| AdminGetSetting | Used to get various server settings such as |
| | throttling thresholds, version numbers and |
| | configuration parameters. |
| AdminSetSetting | Used to set various server settings such as |
| | throttling thresholds, version numbers and |
| | configuration parameters. |

TABLE 2
User Admin Functions

| Function | Description |
|---|---|
| AdminEnableUser | Enable a user's access to the dispatch API. |
| AdminDisableUser | Disable a user's access to the dispatch |
| | API. |
| AdminCompanyList | Retrieve a list of companies with access to |
| | the dispatch API |
| AdminGetUser | Retrieve a user's dispatch API access |
| | profile. For example: |
| | Hours of Operation |
| | Active date range |
| | User's priority level |
| | Allowed transaction objects |
| AdminGetUserAccessProfile | Get a user's dispatch API access profile. |
| | For example hours of operation and date |
| | range in which the user will be able to |
| | access the dispatch service. |
| AdminUserGetObjects | Get the transaction objects to which a user |
| | has access. |
| AdminUserSetObjects | Set the transaction objects to which a user |
| | has access. |
| AdminUserGetObjectFields | Get the transaction object fields to which |
| | a user has access. |
| AdminUserSetObjectFields | Set the transaction object fields to which |
| | a user has access. |

TABLE 3
User Functions

| Function | Description |
|---|---|
| GetUserList | Retrieve a list of user IDs system wide or for a |
| | particular company. |
| GetUserStatus | Retrieve the created date or the last modified date for a |
| | given user. |
| GetUser | Retrieve a user's login, first name, last name, email, |
| | comment field, and password. |
| SetUser | Sets a user's login, first name, last name, email, |
| | comment field, and password. |
| GetUserAttributes | Retrieve the list of attributes associated with a user. |
| SetUserAttribute | Add/remove an attribute to/from the list of attributes |
| | associated with a user. |
| GetUserTypes | Retrieves the codes/IDs for the Job Entry, Mobile |
| | Worker and Admin user types. |
| SetUserType | Set the user type to Job Entry, Mobile Worker or |
| | Admin. |
| DeleteUser | Delete a user. |

TABLE 4
Vehicle Functions

| Function | Description |
|---|---|
| GetVehicleList | Retrieve a list of vehicle IDs system wide or for a |
| | particular company. |
| GetVehicleStatus | Retrieve the created date or the last modified date |
| | for a given vehicle. |
| GetVehicle | Retrieve a vehicle's ID, license, contact and |
| | comment field. |
| SetVehicle | Set a vehicle's ID, license, contact and comment |
| | field. |
| DelVehicle | Delete a vehicle. |
| GetVehicleAttributes | Retrieve the list of attributes associated with a |
| | vehicle. |
| SetVehicleAttribute | Add/remove an attribute to/from the list of |
| | attributes associated with a vehicle. |

TABLE 5
Mass Data Export Functions

| Function | Description |
|---|---|
| DownloadAccounts | Retrieve account information for a single |
| | account, range of accounts or system wide. |
| | Account fields include: |
| | ACCOUNT_NAME |
| | ACCOUNT_ID |
| | ACCOUNT_CONMENTS |
| | ACCOUNT_ADDRESS_TYPE |
| | ACCOUNT_ADDRESS_LOCATION |
| | ACCOUNT_ADDRESS_CONTACT |
| | ACCOUNT_ADDRESS_PHONE |
| | ACCOUNT_ADDRESS_EXT |
| | ACCOUNT_ADDRESS_STREET_NUM |
| | ACCOUNT_ADDRESS_STREET |
| | ACCOUNT_ADDRESS_SUITE |
| | ACCOUNT_ADDRESS_CITY |
| | ACCOUNT_ADDRESS_STATE_PROV |
| | ACCOUNT_ADDRESS_COUNTRY |
| | ACCOUNT_ADDRESS_POSTAL_CODE |
| | ACCOUNT_ADDRESS_COMMENTS |
| | ACCOUNT_STATUS |
| DownloadAttributes | Retrieve the list of attributes associated with an |
| | account, a range of accounts or system wide. |
| DownloadErrataAddress | Retrieve the list of errata addresses associated |
| | with an account, a range of accounts or system |
| | wide. |
| DownloadLocation | Retrieve the list of locations associated with an |
| | account, a range of accounts or system wide. |
| DownloadUsers | Retrieve the list of users associated with an |
| | account, a range of accounts or system wide. |
| DownloadJobs | Retrieve the list of jobs associated with an |
| | account, a range of accounts or system wide. |
| DownloadZones | Retrieve the list of zones associated with an |
| | account, a range of accounts or system wide. |
| DownloadTimers | Retrieve the list of timers associated with an |
| | account, a range of accounts or system wide. |
| DownloadVehicles | Retrieve the list of vehicles associated with an |
| | account, a range of accounts or system wide. |

The functions described in the above tables will all be called utilizing the method:

http://www.<site_name>.com/<dir_name>/eDAPI.asp?CMD=<func_name>

The use of this method is described earlier in this document. However, it is worth noting that <func_name>represents one of the functions listed in the tables. The <func_name> may include zero, one or more arguments with the called function.

The web dispatch system described herein requires no special software such as DCOM, IIOP or CORBA to access the dispatch services. No special middle-ware or custom versions of HTTP, HTML or TCP/IP is required. Standard programming languages such as C and C++ can be used to write computer applications to easily interface with the dispatch component 400 via the dispatch API 426. Similarly, manual query of the system may be performed by entering the dispatch API 426 function calls directly into the command line of a standard web browser such as Netscape™ or Microsoft Explorer™ . Additionally, use of standard HTTP syntactic conventions means that no special ports on the public web server 410 need to be configured. Definition of a set of function calls based on the present syntactic capabilities of HTTP has enabled a simple, effective solution to a problem at minimal cost to the end user.

The above-described embodiments should be regarded as illustrative rather than restrictive, and it should be appreciated that variations may be made other than those discussed, by workers of ordinary skill in the art without departing from the scope of the present invention as defined by the following claims.

What is claimed is:

1. A method of making a function call from a web browser running on an internet appliance, comprising the steps of:
(a) generating a Uniform Resource Locator (URL) that includes a web server address, a default page address name and a function name;
(b) sending said URL over a network;
(c) receiving said URL at a server; and
(d) executing a function corresponding to said function name in said URL.

2. The method according to claim 1, wherein said function name includes at least one function argument.

3. The method according to claim 1, wherein said function name includes zero arguments.

4. The method according to claim 1, wherein said URL further includes a user ID and company ID and a password.

5. The method according to claim 4, further including the step of authenticating said user ID, said company ID and said password after step (c) and prior to step (d).

6. The method according to claim 1, including after step (d), the step of forwarding a result of executing said function to said internet appliance.

7. The method according to claim 6, wherein said result is an XML document.

8. The method according to claim 6, wherein said result is a WEB page.

9. The method according to claim 1, wherein said network is a local network.

10. The method according to claim 1, wherein said network is a wireless network.

11. The method according to claim 1, wherein said network is the Internet.

12. The method according to claim 1, wherein said network is two or more utilized in combination selected from the group consisting of a local network, a wireless network, and the Internet.

13. A method of making a request from a web browser running on an internet appliance, comprising the steps of:
(a) generating a Uniform Resource Locator (URL) that includes a web server address, a default page address name and a function name;
(b) sending said URL over a network;
(c) receiving said URL at a server;
(d) executing a function corresponding to said function name in said URL;
(e) generating a result; and
(f) sending said result to said Internet appliance.

14. The method according to claim 13, wherein said result is an indicator of success or failure of an operation performed by executing said function.

15. The method according to claim 14, wherein said result further includes one or more records.

16. The method according to claim 13, wherein said result is a WEB document.

17. The method according to claim 13, wherein said result is an XML document.

18. The method according to claim 13, wherein said network is a local network.

19. The method according to claim 13, wherein said network is a wireless network.

20. The method according to claim 13, wherein said network is the Internet.

21. The method according to claim 13, wherein said network is two or more utilized in combination selected from the group consisting of a local network, a wireless network, and the Internet.
